(19) United States
(12) Patent Application Publication
(10) Pub. No.: US 2012/0110816 A1
(43) Pub. Date: May 10, 2012

(54) Engine Loading System

(75) Inventors: Oliver J. Groves, Freeland, WA (US); Michael H. Konen, Marysville, WA (US); Thomas D. Mayor, Burien, WA (US)

(73) Assignee: THE BOEING COMPANY, Chicago, IL (US)

(21) Appl. No.: 12/941,584

(22) Filed: Nov. 8, 2010

(51) Int. Cl. B23P 11/00; B66F 7/00; B64F 5/00; B66F 7/16; B66F 7/10; B66F 5/00; B66F 7/14

(52) U.S. Cl. 29/428; 254/2 R; 254/7 C; 414/589

(57) ABSTRACT

A method and apparatus for moving an engine. The engine may be moved in a cradle with respect to a location on an aircraft using a movement system associated with the cradle. A position of the cradle with respect to the movement system and the location on the aircraft may be changed using an adjustment system associated with the movement system. The engine may be connected to the location after changing the position of the cradle.

### BACKGROUND INFORMATION

1. Field:

The present disclosure relates generally to aircraft and, in particular, to engines for aircraft. Still more particularly, the present disclosure relates generally to a method and apparatus for moving an engine relative to an aircraft.

2. Background:

An aircraft engine is a propulsion system for aircraft. With commercial aircraft, the engine typically may take the form of a turbo jet, a turbo fan, or some other suitable type of jet engine. When manufacturing aircraft, these types of engines may be installed in the aircraft as part of the assembly process. Typically, an engine may be attached to a strut in the wing or in some other location on the aircraft.

In installing an engine, the engine may be typically located on a dolly or some other structure. This dolly may be, for example, without limitation, moved to place the engine in a location relative to the aircraft. Once the engine is moved into a position relative to the aircraft, the engine may still need to be positioned using another tool. A bootstrap tool may be, for example, without limitation, a mechanical system configured to raise the engine from the dolly, such that the engine can be attached to the strut. The bootstrap tool may be attached to the wing of the aircraft. Thereafter, the bootstrap tool may be attached to the engine and raise the engine into position for installation.

In other cases, a crane may be present in the area in which the aircraft is being manufactured. The crane may be used with an engine overhead sling to raise the engine and position it relative to the aircraft for installation.

With these and other currently used systems, the equipment may be larger and heavier than desired. Further, the cost to maintain the equipment and make sure the equipment is available in different facilities also may increase the expense and time needed. For example, during maintenance, similar equipment for removing the engine for maintenance also may be used. After maintenance is performed, the engine may then be re-attached with this same type of equipment.

Further, the use of currently available equipment for installing and removing engines from aircraft may require more operators than desired.

Therefore, it would be advantageous to have a method and apparatus that takes into account at least one of the issues discussed above, as well as other possible issues.

### SUMMARY

In one advantageous embodiment, an apparatus may comprise a cradle, a movement system, and an adjustment system. The cradle may be configured to hold an engine. The movement system may be associated with the cradle and configured to move the cradle. The adjustment system may be configured to change a position of the cradle with respect to the movement system.

In another advantageous embodiment, an engine loader may comprise a cradle, a movement system, and an adjustment system. The cradle may be configured to hold an engine. The movement system may be associated with the cradle and configured to move the cradle. The movement system may comprise a platform associated with the cradle and a plurality of wheels associated with the platform. The adjustment system may be configured to change a position of the cradle with respect to the movement system and an engine strut on an aircraft. The adjustment system may comprise an actuator system and air bearing system. The actuator system may be associated with the cradle. The actuator system may comprise a number of actuators associated with the cradle. Each actuator in the number of actuators may be selected from a group comprising a hydraulic actuator, a machine screw, a ball screw jack, and a telescope jack. A number of universal joints may be associated with the number of actuators and may be located on a number of ends of the number of actuators associated with the cradle. Each universal joint in the number of universal joints may comprise a spherical bearing, a compression spring configured to center the spherical bearing, and an elongate member.

In yet another advantageous embodiment, a method may be provided for moving an engine. The engine may be moved in a cradle with respect to a location on an aircraft using a movement system associated with the cradle. A position of the cradle with respect to the movement system and the location on the aircraft may be changed using an adjustment system associated with the movement system. The engine may be connected to the location after changing the position of the cradle.

In still yet another advantageous embodiment, a method may be provided for moving an engine. The engine may be moved in a cradle with respect to an engine strut on an aircraft using a movement system associated with the cradle. A position of the cradle with respect to the movement system and the engine strut on the aircraft may be changed using an adjustment system associated with the movement system to move the engine into a desired position relative to the engine strut on the aircraft. In changing the position of the cradle, a height of the cradle may be changed using an actuator system to change a height of the engine, and an alignment of the cradle may be adjusted using an air bearing system to adjust an alignment of the engine. The engine may be bolted in the desired position to the engine strut after changing the position of the cradle. The position of the cradle may be changed with respect to the movement system and the location on the aircraft using the adjustment system associated with the movement system to move the cradle away from the engine. The movement system may be moved away from the location on the aircraft after moving the cradle away from the engine. The movement system may be moved away from the location on the aircraft after moving the cradle away from the engine. The movement system may be moved away from the engine after connecting the engine to the engine strut on the aircraft.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of an aircraft manufacturing and service method in accordance with an advantageous embodiment;

FIG. 2 is an illustration of an aircraft in which an advantageous embodiment may be implemented;

FIG. 3 is an illustration of an engine movement environment in accordance with an advantageous embodiment;

FIG. 4 is an illustration of a perspective view of an engine movement system in accordance with an advantageous embodiment;

FIG. 5 is an illustration of a bottom view of an engine movement system in accordance with an advantageous embodiment;

FIG. 6 is an illustration of an enlarged partially-phantom view of a portion of an engine movement system in accordance with an advantageous embodiment;

FIG. 7 is an illustration of an enlarged partially-phantom view of a portion of an engine movement system in accordance with an advantageous embodiment;

FIG. 8 is an illustration of an engine in a cradle for an engine movement system in accordance with an advantageous embodiment;

FIG. 9 is an illustration of an engine movement system in accordance with an advantageous embodiment;

FIG. 10 is an illustration of a flowchart of a process for moving an engine in accordance with an advantageous embodiment;

FIG. 11 is an illustration of a flowchart of a process for attaching an engine to an engine strut in accordance with an advantageous embodiment; and

FIG. 12 is an illustration of a flowchart for disconnecting an engine from an engine strut in accordance with an advantageous embodiment.

### DETAILED DESCRIPTION

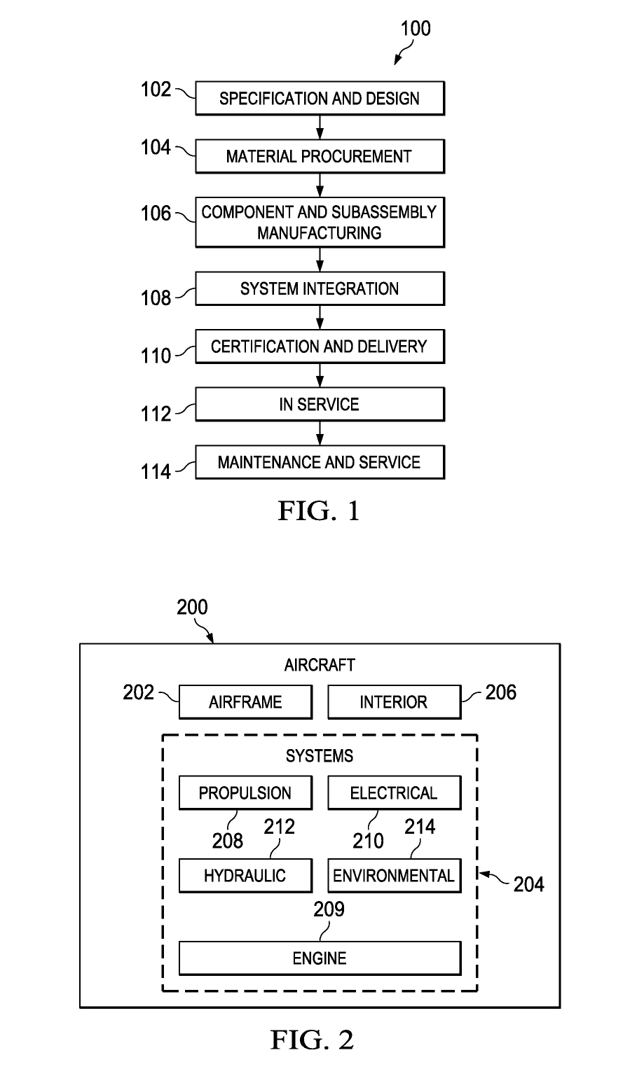

Referring more particularly to the drawings, embodiments of the disclosure may be described in the context of aircraft manufacturing and service method 100 as shown in FIG. 1 and aircraft 200 as shown in FIG. 2. Turning first to FIG. 1, an illustration of an aircraft manufacturing and service method is depicted in accordance with an advantageous embodiment. During pre-production, aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service 112 by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, an illustration of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 may include one or more of propulsion system 208, engine system 209, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during at least one of the stages of aircraft manufacturing and service method 100 in FIG. 1. As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C or item B and item C.

In one illustrative example, components or subassemblies produced in component and subassembly manufacturing 106 in FIG. 1 may be fabricated or manufactured in a manner similar to components or subassemblies produced while aircraft 200 is in service 112 in FIG. 1. As yet another example, a number of apparatus embodiments, method embodiments, or a combination thereof may be utilized during production stages, such as component and subassembly manufacturing 106 and system integration 108 in FIG. 1. A number, when referring to items, means one or more items. For example, a number of apparatus embodiments may be one or more apparatus embodiments.

A number of apparatus embodiments, method embodiments, or a combination thereof may be utilized while aircraft 200 is in service 112 and/or during maintenance and service 114 in FIG. 1. The use of a number of the different advantageous embodiments may substantially expedite the assembly of and/or reduce the cost of assembling aircraft 200.

The different advantageous embodiments recognize and take into account a number of different considerations. For example, without limitation, the different advantageous embodiments recognize and take into account that the equipment for the currently available systems for moving engines for installation and removing engines from aircraft may be larger and more expensive than desired.

Further, the different advantageous embodiments recognize and take into account that, with the currently used systems, the equipment may be needed at each facility in which an engine may be moved for installation or when being removed from an aircraft. The different advantageous embodiments recognize and take into account that having the equipment present and maintaining these systems may be more expensive than desired. Further, the different advantageous embodiments also recognize and take into account that the number of operators needed to install or remove an engine may be greater than desired.

The different advantageous embodiments recognize and take into account that it may be desirable to have a simpler system for moving an engine. For example, without limitation, the different advantageous embodiments recognize and take into account that it may be desirable to have a system that may be shipped with the engine without requiring the equipment to be initially present at the location of the aircraft to install an engine to the aircraft.

Thus, the different advantageous embodiments provide a method and apparatus for moving an engine. In one advantageous embodiment, an apparatus may comprise a cradle, a movement system, and an adjustment system. The cradle may be configured to hold an engine. The movement system may be associated with the cradle and may be configured to move the cradle. The adjustment system may be configured to change a position of the cradle relative to the movement system.

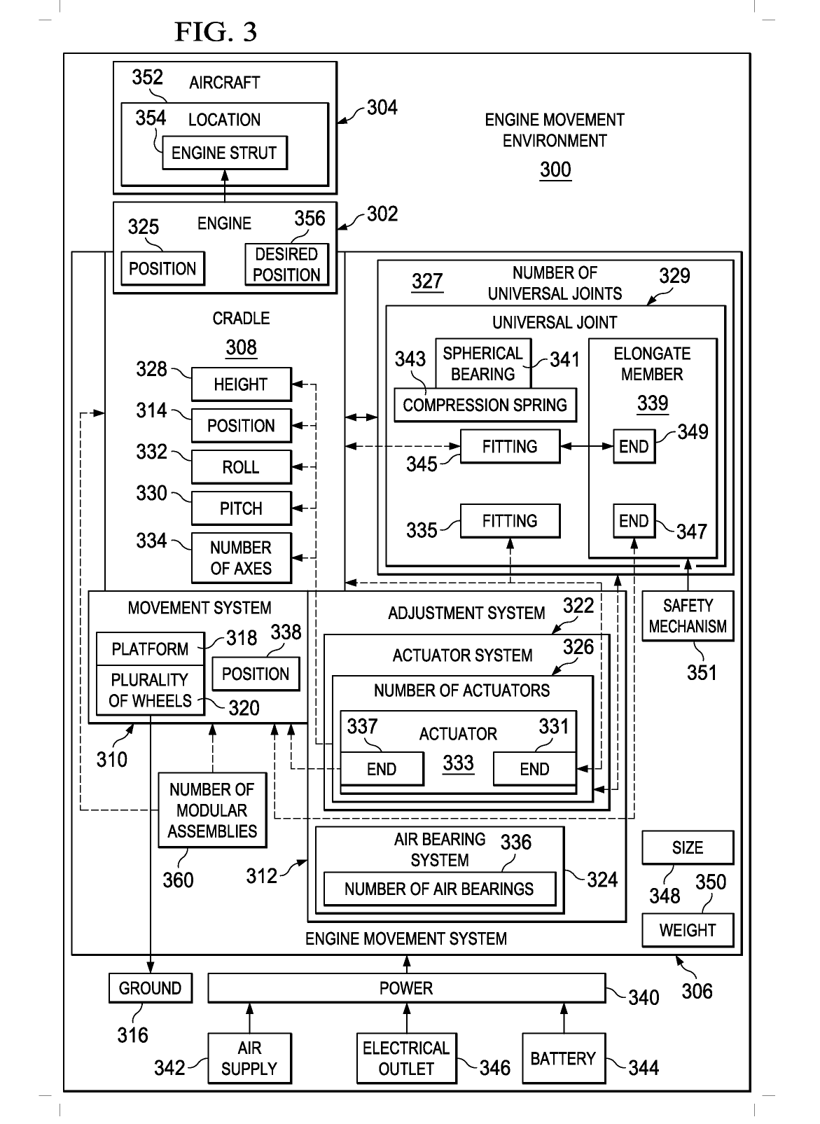

With reference now to FIG. 3, an illustration of an engine movement environment is depicted in accordance with an advantageous embodiment. In this illustrative example, engine movement environment 300 may be used to move engine 302 relative to aircraft 304. Aircraft 304 may be, for example, without limitation, aircraft 200 in FIG. 2.

In these illustrative examples, engine 302 may be moved relative to aircraft 304 during different phases of aircraft manufacturing and service method 100 in FIG. 1. For example, without limitation, engine 302 may be moved to install engine 302 in aircraft 304 during system integration 108 in aircraft manufacturing and service method 100 in FIG. 1. As yet another example, engine 302 may be installed or removed from aircraft 304 during maintenance and service 114 in aircraft manufacturing and service method 100 in FIG. 1.

In these illustrative examples, engine 302 may be moved relative to aircraft 304 using engine movement system 306. Engine movement system 306 may include cradle 308, movement system 310, adjustment system 312, as well as, possibly, other components not illustrated in this example.

Cradle 308 may be configured to hold engine 302. Movement system 310 may be associated with cradle 308. A first component may be considered to be associated with a second component by being secured, attached, bonded, fastened, and/or mounted to the second component. Further, the first component may be associated with the second component by being connected to the second component in some other suitable manner. Still further, the first component also may be connected to the second component by using a third component. The first component may also be considered to be associated with the second component by being formed as part of and/or an extension of the second component.

Further, movement system 310 may be configured to move cradle 308 relative to aircraft 304. Adjustment system 312 may be associated with cradle 308 and/or movement system 310. Adjustment system 312 may be configured to change position 314 of cradle 308 with respect to movement system 310.

In this illustrative example, movement system 310 may move on ground 316. Movement system 310 may comprise platform 318 and plurality of wheels 320. Of course, in other illustrative embodiments, other mobility mechanisms may be used in addition to, or in place of, plurality of wheels 320. For example, without limitation, feet and/or tracks may be used.

In these illustrative examples, adjustment system 312 may comprise actuator system 322 and air bearing system 324. Actuator system 322 may include number of actuators 326. Number of actuators 326 may take a number of different forms. For example, without limitation, number of actuators 326 may include at least one of a hydraulic actuator, a machine screw, a ball jack screw, a telescope jack, and some other suitable type of actuator. One or more of these types of actuators may be used to implement an actuator in number of actuators 326.

In these illustrative examples, number of actuators 326 in actuator system 322 may change height 328 of cradle 308 in changing position 314 of cradle 308 relative to aircraft 304. Additionally, in some illustrative examples, number of actuators 326 may be used to adjust one of pitch 330 and roll 332 of cradle 308 in addition to changing height 328. In other words, number of actuators 326 may change position 314 of cradle 308 in number of axes 334 in these illustrative examples. Further, in this manner, number of actuators 326 may also change position 325 of engine 302 in cradle 308 relative to aircraft 304.

As depicted in these examples, engine movement system 306 may also include number of universal joints 327 associated with number of actuators 326. Number of universal joints 327 may allow number of actuators 326 to be connected to cradle 308.

In these illustrative examples, universal joint 329 may be an example of one of number of universal joints 327. Universal joint 329 may be associated with end 331 of actuator 333 in number of actuators 326. End 331 may be the end of actuator 333 that is associated with cradle 308. End 337 of actuator 333 may be opposite to end 331. End 337 may be associated with movement system 310.

Universal joint 329 may include elongate member 339, spherical bearing 341, compression spring 343, fitting 345, and fitting 335. In these illustrative examples, elongate member 339 may be associated with movement system 310 and cradle 308. For example, without limitation, end 347 of elongate member 339 may be connected to movement system 310.

Fitting 345 may connect end 349 of elongate member 339 to cradle 308. Fitting 345 may be, for example, without limitation, a clamp configured to clamp elongate member 339 to cradle 308. Similarly, fitting 335 may be configured to connect actuator 333 at end 331 of actuator 333 to elongate member 339.

Additionally, compression spring 343 may be configured to center spherical bearing 341. Compression spring 343 may center spherical bearing 341 to reduce bending of elongate member 339. In other words, compression spring 343 may center spherical bearing 341 to apply pressure that may increase the rigidity of elongate member 339. This increased rigidity may allow cradle 308 to remain stable relative to movement system 310 when cradle 308 is moved.

Further, in some illustrative examples, engine movement system 306 may include safety mechanism 351. Safety mechanism 351 may be configured to substantially prevent elongate member 339 of universal joint 329 from extending and/or retracting in an undesired manner. In other words, elongate member 339 may be substantially prevented from moving upwards and/or downwards more than desired.

As depicted in these examples, air bearing system 324 may include number of air bearings 336. Number of air bearings 336 in air bearing system 324 may be used to adjust position 314 of cradle 308. In these illustrative examples, position 314 may be adjusted by adjusting position 338 of movement system 310. In other words, air bearing system 324 may adjust position 338 of engine movement system 306. Air bearing system 324 may be used during movement of movement system 310 along ground 316 and/or during positioning of cradle 308 relative to aircraft 304 with adjustment system 312.

For example, in these illustrative examples, air bearing system 324 may raise engine movement system 306 to take into account unevenness in ground 316. Further, air bearing system 324 may be used to rotate engine movement system 306. In other words, air bearing system 324 may be used to float engine movement system 306.

In these illustrative examples, power 340 for engine movement system 306 may be provided through a number of different sources. For example, without limitation, power 340 may be provided using air supply 342. Air supply 342 may provide power 340 to operate air bearing system 324 and actuator system 322. In other illustrative examples, power 340 may also be provided using battery 344 and/or electrical outlet 346, depending on the type of actuators in actuator system 322.

Thus, the different advantageous embodiments provide a capability to move engine 302 relative to aircraft 304 without additional equipment as currently used. In other words, a bootstrap, a crane, and/or other equipment may be unnecessary.

With the different advantageous embodiments, the movement of engine 302 may be provided as part of engine movement system 306. In these illustrative examples, engine movement system 306 may have at least one of size 348 and weight 350 suitable for shipping engine movement system 306 with aircraft 304. In other words, engine 302 may be, for example, without limitation, shipped in cradle 308 of engine movement system 306. As a result, the equipment needed to attach engine 302 to aircraft 304 may be moved with engine 302 during shipping.

In these illustrative examples, engine movement system 306 may be configured to move and position cradle 308 with respect to location 352 on aircraft 304. Location 352 may be engine strut 354 on aircraft 304. In these examples, cradle 308 may be moved to engine strut 354 on aircraft 304 to install engine 302. Installing engine 302 may include attaching engine 302 to engine strut 354.

For example, without limitation, after movement system 310 is moved to engine strut 354, adjustment system 312 may be configured to change position 314 of cradle 308 to move engine 302 in cradle 308 into desired position 356 relative to engine strut 354. Once engine 302 has desired position 356 relative to engine strut 354, engine 302 may be connected to engine strut 354.

As used herein, when a first component, such as engine 302, is connected to a second component, such as engine strut 354, the first component may be connected to the second component without any additional components between the two components connected to each other. The first component also may be connected to the second component by one or more other components. Further, the first component may be connected to the second component by being secured, attached, bonded, fastened, bolted, welded, mounted, and/or connected in some other suitable manner to the second component.

Cradle 308 may, in these examples, be disconnected from engine 302 and moved away from location 352 on aircraft 304. In these illustrative examples, engine movement system 306 may also be used to remove engine 302 from location 352 on aircraft 304.

The illustration of engine movement environment 300 in FIG. 3 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some advantageous embodiments, additional movement systems in addition to engine movement system 306 may be present to move other engines in addition to engine 302. In still other illustrative examples, engine movement system 306 may be operated using a computer, through human operators, or a combination of the two.

In some illustrative examples, one or more of number of air bearings 336 may be raised and/or lowered using other components and/or tools in addition to the ones described. For example, without limitation, a crank handle (not shown), may be used to raise and/or lower one or more of number of air bearings 336. Still further, in some illustrative examples, other components, such as a stowage container (not shown), may be included in engine movement system 306.

In other illustrative examples, cradle 308 may include portable work stands associated with cradle 308. These portable work stands may be used to connect cradle 308 to engine 302. In still other illustrative examples, all of number of universal joints 327 may not have compression spring 343. For example, without limitation, universal joint 339 may not have compression spring 343, while all other universal joints in number of universal joints 327 have compression spring 343. Further, spherical bearing 341 for universal joint 329 may be fixed such that spherical bearing 341 forms a pivot point for cradle 308. In this manner, cradle 308 may be rotated about pivot point in about 360 degrees.

In some illustrative examples, cradle 308 and movement system 310 may be implemented using currently available systems. When currently available systems are used for cradle 308 and movement system 310, adjustment system 312 may take the form of number of modular assemblies 360. Each of number of modular assemblies 360 may include an actuator from number of actuators 326, an air bearing from number of air bearings 336, and/or other suitable components.

Number of modular assemblies 360 may be attached to at least one cradle 308 and movement system 310 to form engine movement system 306. In this manner, additional equipment, other than engine movement system 306, may not be needed for moving engine 302.

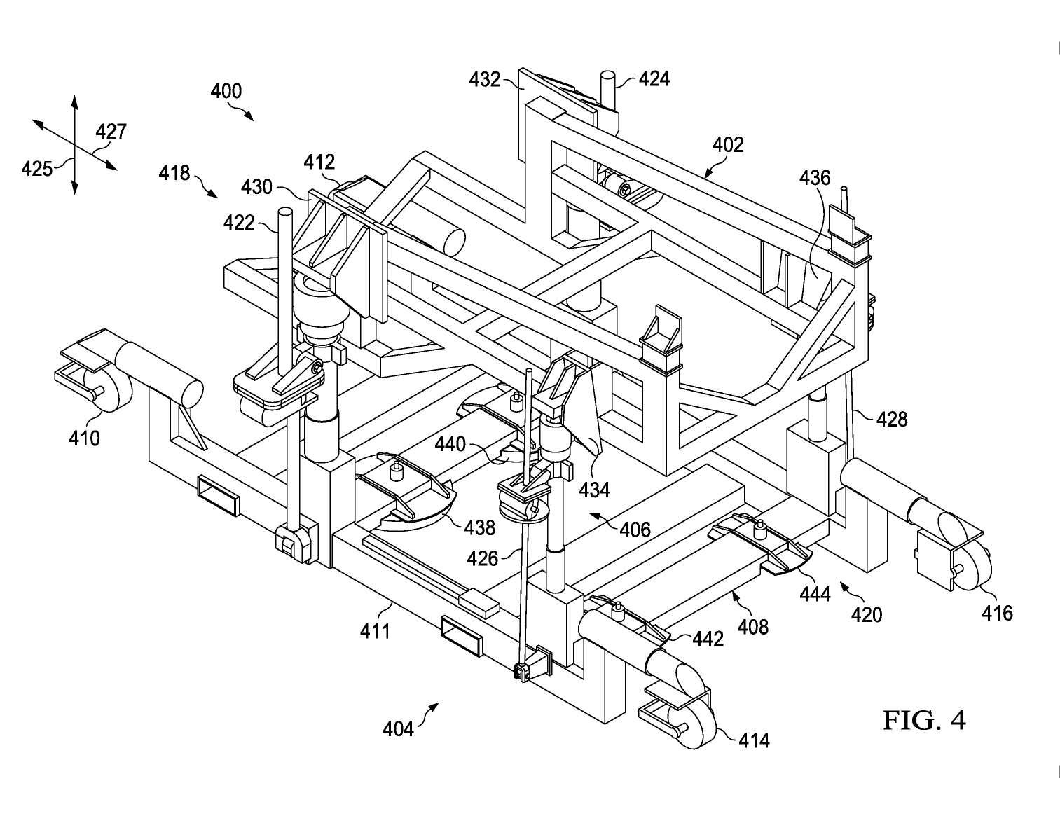

With reference now to FIG. 4, an illustration of a perspective view of an engine movement system is depicted in accordance with an advantageous embodiment. In this illustrative example, engine movement system 400 may be an example of one implementation for engine movement system 306 in FIG. 3.

As depicted, engine movement system 400 may include cradle 402, movement system 404, and adjustment system 406. Cradle 402 is configured to hold an engine, such as engine 302 in FIG. 3. Movement system 404 is associated with cradle 402.

As illustrated, movement system 404 may include platform 408 and wheels 410, 412, 414, and 416 connected to platform 408. In particular, wheels 410, 412, 414, and 416 may be connected to platform 408 at bottom 411 of engine movement system 400. Wheels 410, 412, 414, and 416 may allow movement system 404 to move over a surface, such as ground 316 in FIG. 3.

In this illustrative example, adjustment system 406 may be associated with movement system 404. Further, adjustment system 406 may be associated with cradle 402. Adjustment system 406 may be configured to change a position of cradle 402. As depicted, adjustment system 406 may include actuator system 418 and air bearing system 420.

In this depicted example, actuator system 418 may include actuators 422, 424, 426, and 428. In this illustrative example, actuators 422, 424, 426, and 428 may take the form of machine screws. Of course, in other illustrative examples, other types of actuators, such as, for example, without limitation, hydraulic actuators, may be used.

Actuators 422, 424, 426, and 428 may be associated with universal joints 430, 432, 434, and 436, respectively. In this illustrative example, universal joints 430, 432, 434, and 436 may connect actuators 422, 424, 426, and 428, respectively, to cradle 402. In particular, these universal joints may connect these actuators to cradle 402 such that cradle 402 moves when the actuators move.

In this illustrative example, each of actuators 422, 424, 426, and 428 may be moved independently from the other actuators. In this manner, the height and/or position of cradle 402 in a number of axes may be changed. For example, without limitation, the position of cradle 402 relative to movement system 404 may be changed with rotation about axis 425 and/or axis 427. In other words, a pitch and/or roll of cradle 402 may be changed using actuators 422, 424, 426, and 428.

Additionally, each of actuators 422, 424, 426, and 428 may be configured to carry a selected load. Not all of actuators 422, 424, 426, and 428 may be configured to carry the same load in these examples. For example, without limitation, actuator 422 and actuator 424 may be configured to carry a load up to about 20 tons. Actuator 426 and actuator 428 may be configured to carry a load up to about five tons.

As illustrated, air bearing system 420 may include air bearings 438, 440, 442, and 444. Air bearings 438, 440, 442, and 444 may be on bottom 411 of engine movement system 400. Power in the form of air may be supplied to air bearings 438, 440, 442, and 444 using, for example, without limitation, air supply 342 in FIG. 3.

Air bearings 438, 440, 442, and 444 may allow adjustments to be made to the movement of engine movement system 400. For example, without limitation, engine movement system 400 may be raised above a surface, floated, positioned, rotated, and/or moved in some other suitable manner using air bearings 438, 440, 442, and 444.

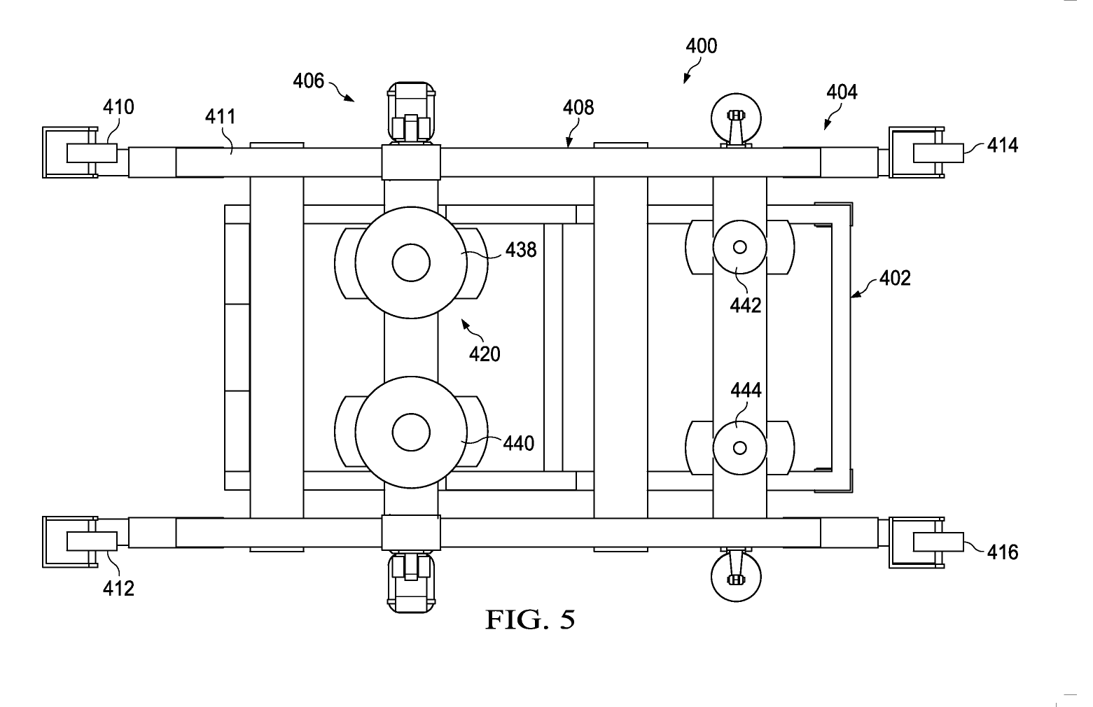

With reference now to FIG. 5, an illustration of a bottom view of an engine movement system is depicted in accordance with an advantageous embodiment. In this illustrative example, a bottom view of engine movement system 400 from FIG. 4 may be depicted from bottom 411 such that air bearing system 420 may be seen more clearly.

Air bearings 438, 440, 442, and 444 may have substantially the same size, or different sizes. As depicted, air bearing 438 and air bearing 440 may have substantially the same size. In this illustrative example, air bearing 438 and air bearing 440 may have a diameter of about 27 inches. This diameter may allow each of these air bearings to carry a load up to about 12,000 pounds.

Further, air bearing 442 and air bearing 444 may have substantially the same size. In this illustrative example, air bearing 442 and air bearing 444 may have a diameter of about 15 inches. This diameter may allow each of these air bearings to carry a load up to about 3,500 pounds.

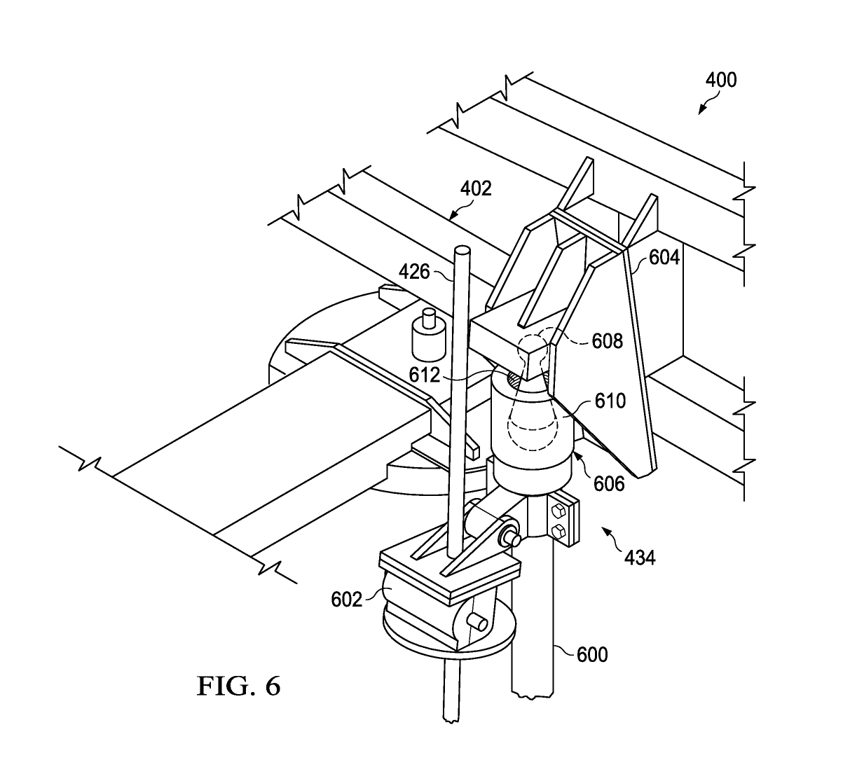

With reference now to FIG. 6, an illustration of an enlarged partially-phantom view of a portion of an engine movement system is depicted in accordance with an advantageous embodiment. In this illustrative example, an enlarged partially-phantom view of universal joint 434 connecting actuator 426 to cradle 402 may be depicted to provide a more-detailed view of universal joint 434.

As depicted, universal joint 434 may include elongate member 600, fitting 602, fitting 604, spring assembly 606, and spherical bearing 608. In this illustrative example, elongate member 600 may also be referred to as a shaft. Fitting 602 may be configured to connect elongate member 600 to actuator 426. Fitting 604 may be configured to connect elongate member 600 to cradle 402. Fitting 604 may take the form of a clamp in this example.

In this illustrative example, spring assembly 606 may include housing 610 and compression spring 612 associated with housing 610. In particular, compression spring 612 may be located inside housing 610. Further, as depicted, spherical bearing 608 may also be located inside housing 610. Compression spring 612 may be configured to center spherical bearing 608 and increase the rigidity of elongate member 600 to reduce bending of elongate member 600.

Universal joint 436 connecting actuator 428 to cradle 402 in FIG. 4 may be configured in substantially the same manner as universal joint 434 in these illustrative examples.

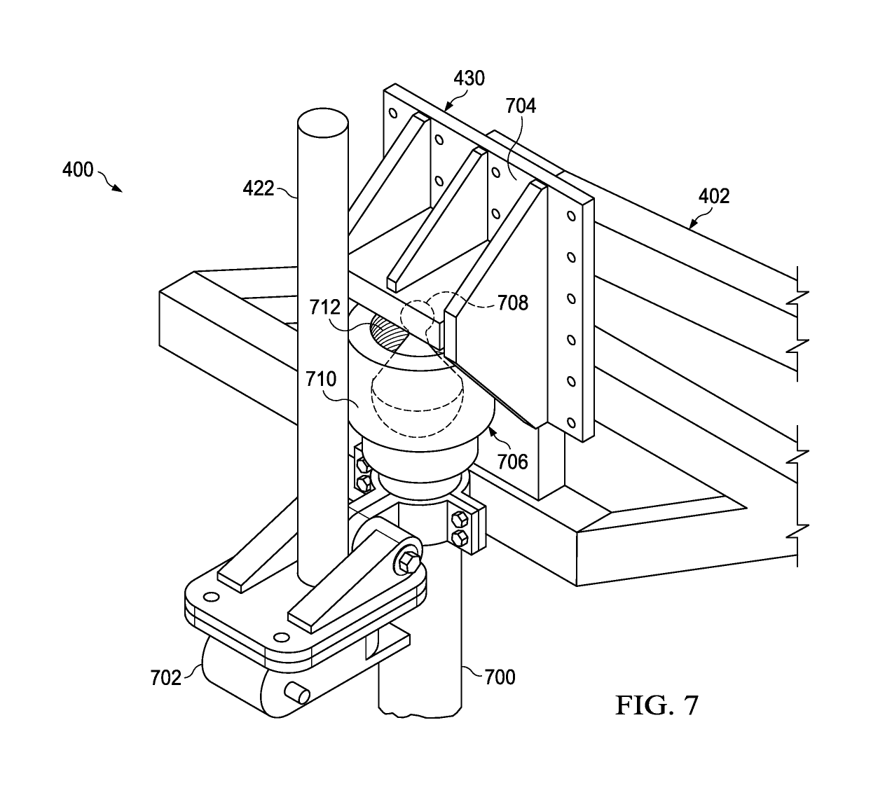

With reference now to FIG. 7, an illustration of an enlarged partially-phantom view of a portion of an engine movement system is depicted in accordance with an advantageous embodiment. In this illustrative example, an enlarged partially-phantom view of universal joint 430 connecting actuator 422 to cradle 402 may be depicted to provide a more-detailed view of universal joint 430.

As depicted, universal joint 430 may include elongate member 700, fitting 702, fitting 704, spring assembly 706, and spherical bearing 708. In this illustrative example, elongate member 700 may also be referred to as a shaft. Fitting 702 may be configured to connect elongate member 700 to actuator 422. Fitting 704 may be configured to connect elongate member 700 to cradle 402. Fitting 704 may take the form of a clamp in this example.

In this illustrative example, spring assembly 706 may include housing 710 and compression spring 712 associated with housing 710. In particular, compression spring 712 may be located inside housing 710. Further, as depicted, spherical bearing 708 may also be located inside housing 710. Compression spring 712 may be configured to center spherical bearing 708 and increase the rigidity of elongate member 700 to reduce bending of elongate member 700.

Universal joint 432 connecting actuator 424 to cradle 402 in FIG. 4 may be configured in substantially the same manner as universal joint 430 in these illustrative examples.

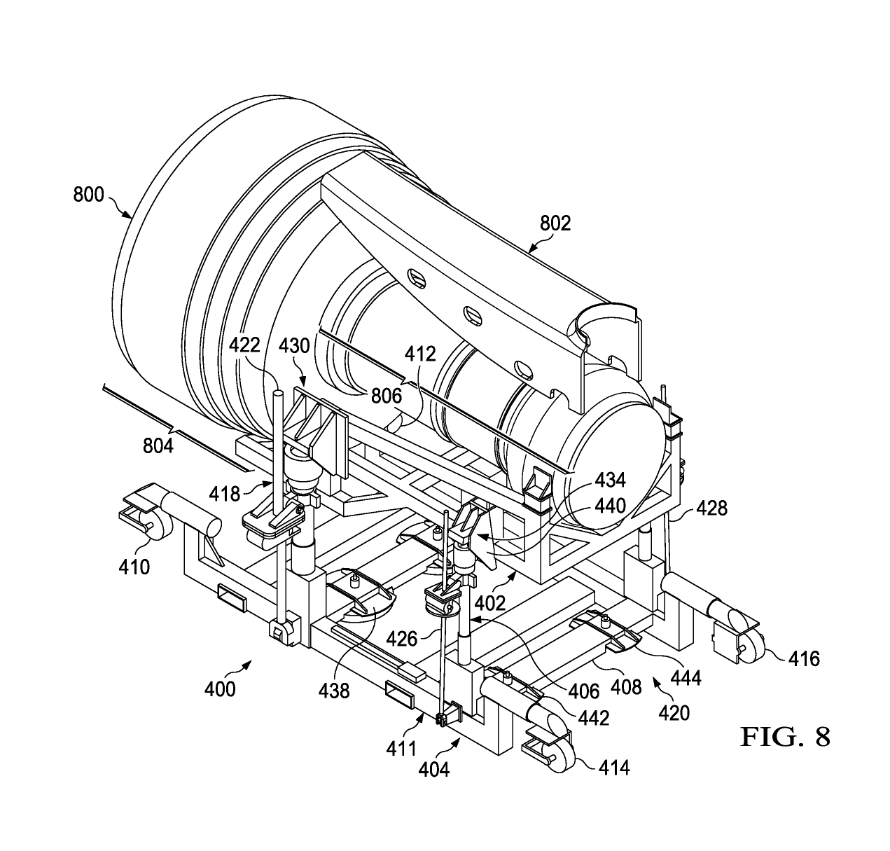

With reference now to FIG. 8, an illustration of an engine in a cradle for an engine movement system is depicted in accordance with an advantageous embodiment. In this illustrative example, engine 800 may be in cradle 402 for engine movement system 400 from FIG. 4. Engine 800 may be an engine for an aircraft, such as aircraft 200 in FIG. 2 and/or aircraft 304 in FIG. 3.

As depicted, engine movement system 400 may be moved to a location at engine strut 802. In this illustrative example, engine strut 802 may be a wing engine strut for the aircraft. Engine 800 may have forward portion 804 and aft portion 806. Forward portion 804 may have a larger size and weight as compared to aft portion 806. In this illustrative example, actuator 422 and actuator 424 in FIG. 4 (not shown in this view) are configured to carry the increased weight of forward portion 804.

Adjustment system 406 for engine movement system 400 may be configured to change the position of cradle 402 to move engine 800 into a desired position at engine strut 802. In the desired position, engine 800 may be attached to engine strut 802. Additionally, adjustment system 406 for engine movement system 400 may be configured to carry engine 800 away from engine strut 802 when engine 800 has been disconnected from engine strut 802.

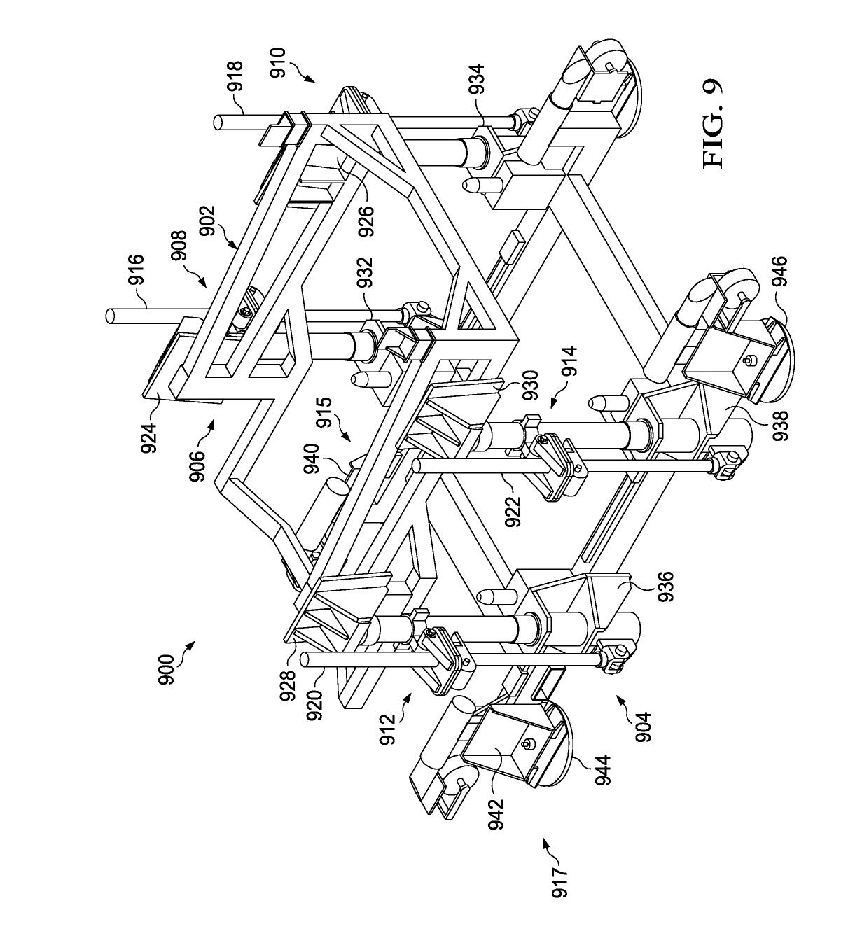

With reference now to FIG. 9, an illustration of an engine movement system is depicted in accordance with an advantageous embodiment. In this illustrative example, engine movement system 900 may be an example of one implementation for engine movement system 306 in FIG. 3.

In this depicted example, engine movement system 900 may include cradle 902, movement system 904, and adjustment system 906. Cradle 902 and movement system 904 may take the form of currently available systems. As illustrated, adjustment system 906 may include modular assemblies 908, 910, 912, 914, 915, and 917 associated with movement system 904 and cradle 902. Modular assemblies 908, 910, 912, 914, 915, and 917 may be examples of implementations of modular assemblies in number of modular assemblies 360 in FIG. 3.

Modular assemblies 908, 910, 912, and 914 may include actuators 916, 918, 920, and 922, respectively. Further, modular assemblies 908, 910, 912, and 914 may include universal joints 924, 926, 928, and 930, respectively. Universal joints 924, 926, 928, and 930 may be configured to connect actuators 916, 918, 920, and 922, respectively, to cradle 902.

Additionally, modular assemblies 908, 910, 912, 914, 915, and 917 may also include fittings 932, 934, 936, 938, 940, and 942, respectively. These fittings may allow the modular assemblies to be connected to movement system 904.

In this illustrative example, modular assembly 917 may also include air bearing 944. Modular assembly 914 may also include air bearing 946. Modular assembly 915 and modular assembly 910 may include air bearings not shown in this view.

Modular assemblies 908, 910, 912, 914, 915, and 917 may be configured to be attached to currently available forms of cradle 902 and movement system 904 to reduce the time, effort, and/or cost of manufacturing engine movement system 900 that can move an engine.

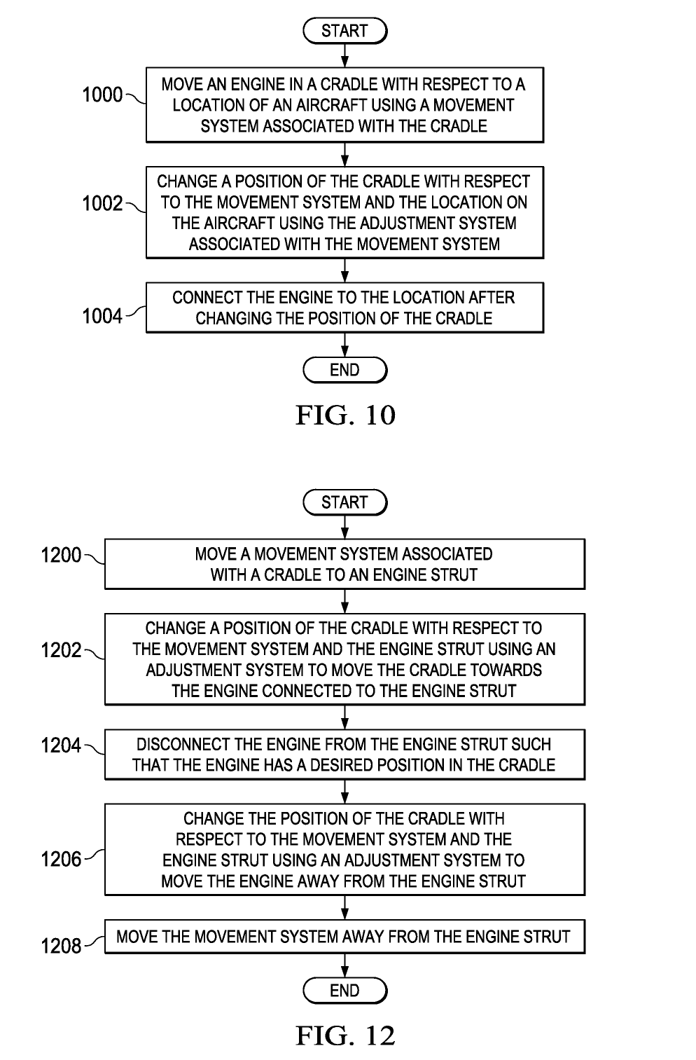

With reference now to FIG. 10, an illustration of a flowchart of a process for moving an engine is depicted in accordance with an advantageous embodiment. The process illustrated in FIG. 10 may be implemented using engine movement system 306 in engine movement environment 300 in FIG. 3. Engine movement system 306 may be used to move, for example, without limitation, engine 302 in FIG. 3.

The process may begin by moving engine 302 in cradle 308 with respect to location 352 on aircraft 304 using movement system 310 associated with cradle 308 (operation 1000). Operation 1000 may be performed using, for example, without limitation, plurality of wheels 320 for movement system 310.

Thereafter, position 314 of cradle 308 may be changed with respect to movement system 310 and location 352 on aircraft 304 using adjustment system 312 associated with movement system 310 (operation 1002). Operation 1002 may be performed to move engine 302 in cradle 308 to desired position 356 such that engine 302 may be connected to location 352. Engine 302 may then be connected to location 352 after changing position 314 of cradle 308 (operation 1004), with the process terminating thereafter.

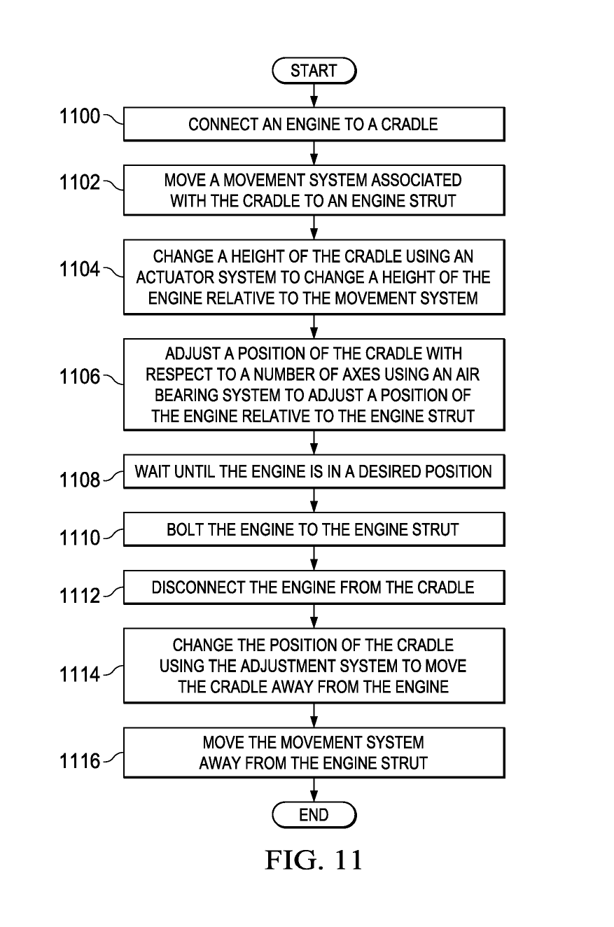

With reference now to FIG. 11, an illustration of a flowchart of a process for attaching an engine to an engine strut is depicted in accordance with an advantageous embodiment. The process illustrated in FIG. 11 may be implemented using engine movement system 306 in engine movement environment 300 to attach engine 302 to engine strut 354 in FIG. 3.

The process may begin by connecting engine 302 to cradle 308 (operation 1100). Operation 1100 may be performed by, for example, without limitation, fastening engine 302 to cradle 308, strapping engine 302 to cradle 308, and/or performing some other suitable operation.

Movement system 310 associated with cradle 308 may then be moved to engine strut 354 (operation 1102). Height 328 of cradle 308 may be changed using actuator system 322 to change a height of engine 302 relative to movement system 310 (operation 1104). Position 314 of cradle 308 with respect to number of axes 334 may be adjusted using air bearing system 324 to adjust position 325 of engine 302 relative to engine strut 354 (operation 1106). In some illustrative examples, operation 1104 and operation 1106 may be performed at substantially the same time.

In this illustrative example, operation 1104 and operation 1106 may be performed repeatedly and/or concurrently to move engine 302 into desired position 356. Thereafter, the process may wait until engine 302 is in desired position 356 (operation 1108).

In response to engine 302 being in desired position 356, engine 302 may be bolted to engine strut 354 (operation 1110). Then, engine 302 may be disconnected from cradle 308 (operation 1112).

Position 314 of cradle 308 may be changed using adjustment system 312 to move cradle 308 away from engine 302 (operation 1114). Thereafter, movement system 310 may be moved away from engine strut 354 (operation 1116), with the process terminating thereafter.

With reference now to FIG. 12, an illustration of a flowchart for disconnecting an engine from an engine strut is depicted in accordance with an advantageous embodiment. The process illustrated in FIG. 12 may be implemented using engine movement system 306 in engine movement environment 300 to disconnecting engine 302 from engine strut 354 in FIG. 3.

The process may begin by moving movement system 310 associated with cradle 308 to engine strut 354 (operation 1200). Position 314 of cradle 308 may be changed with respect to movement system 310 and engine strut 354 using adjustment system 312 to move cradle 308 towards engine 302 connected to engine strut 354 (operation 1202). In operation 1202, cradle 308 may be moved such that position 314 of cradle 308 may allow cradle 308 to receive engine 302.

Engine 302 may then be disconnected from engine strut 354 such that engine 302 has desired position 356 in cradle 308 (operation 1204). Thereafter, position 314 of cradle 308 may be changed again with respect to movement system 310 and engine strut 354 using adjustment system 312 to move engine 302 away from engine strut 354 (operation 1206). Movement system 310 may then be moved away from engine strut 354 (operation 1208), with the process terminating thereafter.

In this manner, engine 302 may be disconnected from engine strut 354 and moved for maintenance, replacement of engine 302, testing, and/or other suitable operations.

The flowcharts and block diagrams in the different depicted embodiments illustrate the architecture, functionality, and operation of some possible implementations of apparatus and methods in different advantageous embodiments. In this regard, each block in the flowcharts or block diagrams may represent a module, segment, function, and/or a portion of an operation or step.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

Thus, the different advantageous embodiments provide a method and apparatus for moving an engine. In one advantageous embodiment, an apparatus may comprise a cradle, a movement system, and an adjustment system. The cradle may be configured to hold an engine. The movement system may be associated with the cradle and may be configured to move the cradle. The adjustment system may be configured to change a position of the cradle relative to the movement system.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a cradle configured to hold an engine;
a movement system associated with the cradle and configured to move the cradle; and
an adjustment system configured to change a position of the cradle with respect to the movement system.

2. The apparatus of claim 1, wherein the movement system comprises:
a platform associated with the cradle; and
a plurality of wheels associated with the platform.

3. The apparatus of claim 1, wherein the adjustment system comprises:
an actuator system associated with the cradle.

4. The apparatus of claim 3, wherein the adjustment system further comprises:
an air bearing system.

5. The apparatus of claim 3, wherein the actuator system comprises a number of actuators associated with the cradle and wherein each actuator in the number of actuators is selected from a group comprising a hydraulic actuator, a machine screw, a ball screw jack, and a telescope jack.

6. The apparatus of claim 5, wherein a number of universal joints is associated with the number of actuators.

7. The apparatus of claim 6, wherein the number of universal joints is located on a number of ends of the number of actuators associated with the cradle.

8. The apparatus of claim 6, wherein each universal joint in the number of universal joints comprises:
a spherical bearing;
a compression spring configured to center the spherical bearing; and
an elongate member.

9. The apparatus of claim 1, wherein the adjustment system is configured to change the position of the cradle with respect to the movement system and a location on an aircraft.

10. The apparatus of claim 9, wherein the location on the aircraft is an engine strut on the aircraft.

11. The apparatus of claim 1 further comprising:
the engine in the cradle.

12. An engine loader comprising:
a cradle configured to hold an engine;
a movement system associated with the cradle and configured to move the cradle in which the movement system comprises:
a platform associated with the cradle; and
a plurality of wheels associated with the platform; and
an adjustment system configured to change a position of the cradle with respect to the movement system and an engine strut on an aircraft in which the adjustment system comprises:
an actuator system associated with the cradle in which the actuator system comprises a number of actuators associated with the cradle; in which each actuator in the number of actuators is selected from a group comprising a hydraulic actuator, a machine screw, a ball screw jack, and a telescope jack; in which a number of universal joints is associated with the number of actuators and is located on a number of ends of the number of actuators associated with the cradle; and in which each universal joint in the number of universal joints comprises:
a spherical bearing;
a compression spring configured to center the spherical bearing; and
an elongate member; and
an air bearing system.

13. A method for moving an engine, the method comprising:
moving the engine in a cradle with respect to a location on an aircraft using a movement system associated with the cradle;
changing a position of the cradle with respect to the movement system and the location on the aircraft using an adjustment system associated with the movement system; and
connecting the engine to the location after changing the position of the cradle.

14. The method of claim 13, wherein the step of changing the position of the cradle with respect to the movement system and the location on the aircraft using the adjustment system associated with the movement system comprises:
changing a height of the cradle using an actuator system to change a height of the engine.

15. The method of claim 13, wherein the step of changing the position of the cradle with respect to the movement system and the location on the aircraft using the adjustment system associated with the movement system comprises:
adjusting an alignment of the cradle using an air bearing system to adjust an alignment of the engine.

16. The method of claim 13, wherein the step of changing the position of the cradle with respect to the movement system and the location on the aircraft using the adjustment system associated with the movement system comprises:
changing the position of the cradle with respect to the movement system and the location on the aircraft using the adjustment system associated with the movement system to move the engine into a desired position relative to the location on the aircraft.

17. The method of claim 16, wherein the step of connecting the engine to the location after changing the position of the cradle comprises:
bolting the engine in the desired position to the location on the aircraft after changing the position of the cradle.

18. The method of claim 13 further comprising:
changing the position of the cradle with respect to the movement system and the location on the aircraft using the adjustment system associated with the movement system to move the cradle away from the engine; and
moving the movement system away from the location on the aircraft after moving the cradle away from the engine.

19. The method of claim 18 further comprising:
moving the movement system to the location on the aircraft;
changing the position of the cradle with respect to the movement system and the location on the aircraft using the adjustment system associated with the movement system to move the cradle towards the engine at the location on the aircraft;
disconnecting the engine from the location on the aircraft such that the engine has a desired position in the cradle;
changing the position of the cradle with respect to the movement system and the location on the aircraft using the adjustment system associated with the movement system to move the engine away from the location on the aircraft; and
moving the movement system away from the location on the aircraft.

20. The method of claim 13, wherein the location is an engine strut on the aircraft.

21. A method for moving an engine, the method comprising:
moving the engine in a cradle with respect to an engine strut on an aircraft using a movement system associated with the cradle;
changing a position of the cradle with respect to the movement system and the engine strut on the aircraft using an adjustment system associated with the movement system to move the engine into a desired position relative to the engine strut on the aircraft in which the changing step comprises:
changing a height of the cradle using an actuator system to change a height of the engine; and
adjusting an alignment of the cradle using an air bearing system to adjust an alignment of the engine;
bolting the engine in the desired position to the engine strut after changing the position of the cradle;
changing the position of the cradle with respect to the movement system and the location on the aircraft using the adjustment system associated with the movement system to move the cradle away from the engine;
moving the movement system away from the location on the aircraft after moving the cradle away from the engine; and
moving the movement system away from the engine after connecting the engine to the engine strut on the aircraft.

22. The method of claim 21 further comprising:
moving the movement system to the engine strut on the aircraft;
changing the position of the cradle with respect to the movement system and the engine strut on the aircraft using the adjustment system associated with the movement system to move the cradle towards the engine at the engine strut on the aircraft;
disconnecting the engine from the engine strut on the aircraft such that the engine has the desired position in the cradle;
changing the position of the cradle with respect to the movement system and the engine strut on the aircraft using the adjustment system associated with the movement system to move the engine away from the engine strut on the aircraft; and
moving the movement system away from the engine strut on the aircraft.
